(19) United States
(12) Patent Application Publication
(10) Pub. No.: US 2010/0012017 A1
(43) Pub. Date: Jan. 21, 2010

(54) DEVICE AND METHOD FOR IDENTIFYING A CHANGE IN A PREDETERMINED CONDITION

(75) Inventor: Neil Miller, Dollard-des-Ormeaux (CA)

Correspondence Address: HOLLAND & HART, LLP, P.O BOX 8749, DENVER, CO, 80201, US

(73) Assignee: LUVGEAR INC., Montreal, QC (CA)

(21) Appl. No.: 12/443,385

(22) PCT Filed: Sep. 27, 2007
(86) PCT No.: PCT/CA07/01722

§ 371 Date: Mar. 27, 2009

Related U.S. Application Data
(60) Provisional application No. 60/827,171, filed on Sep. 27, 2006.

(51) Int. Cl. G01D 21/00; A41D 11/00; A41D 1/00

(52) U.S. Cl. 116/201; 2/69; 116/206; 116/207

(57) ABSTRACT

The present invention provides a device and method which enables the identification of a change in a predetermined condition. The device comprises a fabric material to which is coupled a transitional substance. The transitional substance is configured in order that a change in a predetermined condition, results in an identifiable change in the transitional substance.

### FIELD OF THE INVENTION

The present invention pertains to the field of identification devices and in particular to a device and method configured to identify a change in a predetermined condition.

### BACKGROUND

There are a number of different devices that provide for the evaluation of a condition. For example a thermometer can be used to identify a particular outside temperature or body temperature. This manner in identification can be cumbersome, because if one thinks there is an elevated body temperature one must subsequently get a thermometer to determine if there is any concern. In addition, the current status of other conditions may also be required, for example sun exposure, moisture level or other conditions. Likewise similar to the use of a thermometer, typically cumbersome identification devices may also be required for the evaluation of other conditions.

Therefore there is a need for a device formed from a fabric material which can be used to identify a change in a predetermined condition.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a device and method for identifying a change in a predetermined condition. In accordance with an aspect of the present invention, there is provided a device for identifying a change in a predetermined condition, said device comprising: a fabric material; and a transitional substance coupled to the fabric material, the transitional substance being configured to transform in response to a change in the predetermined condition, wherein the transitional substance transforms in an identifiable manner; thereby enabling identification of the change in the predetermined condition.

In accordance with another aspect of the present invention, there is provided a method for identifying a change in a predetermined condition; the method comprising: providing a device including a fabric material and a transitional substance coupled to the fabric material, the transitional substance being configured to identifiably transform in response to a change in the predetermined condition; detecting a transformation in the transitional substance, said transformation being a response of the transitional substance to a change in the predetermined condition; thereby identifying a change in the predetermined condition.

### BRIEF DESCRIPTION OF THE FIGURES

FIG. 1A illustrates a device according to one embodiment of the present invention.

FIG. 1B is a larger view of the transitional substance having a preconfigured shape according to the embodiment of FIG. 1A.

FIGS. 1C and 1D illustrate alternate predetermined shapes of the transitional substance according to embodiments of the present invention.

FIG. 2A illustrates a device according to another embodiment of the present invention.

FIG. 2B is a larger view of the transitional substance having a predetermined shape according to the embodiment of FIG. 2A.

FIG. 2C shows an alternate predetermined shape for the transitional substance according to another embodiment of the present invention.

FIG. 3 illustrates a predetermined shape of a transitional substance that may be used to respond to a change in a predetermined condition, such as a change in moisture level according to another embodiment of the present invention.

FIG. 4 illustrates a shirt incorporating a transitional substance according to one embodiment of the present invention.

FIG. 5 illustrates a blanket incorporating a transitional substance according to one embodiment of the present invention.

### DETAILED DESCRIPTION OF THE INVENTION

### Definitions

The term “predetermined condition” is used to define an existing state, with reference to an entity including but not limited to a living being or inanimate object. The existing state may also be with reference or regard to the environment proximate to the entity, including but not limited to the atmospheric state proximate to an entity or state of a second entity proximate to a first entity. Examples of existing states, include but are not limited to, temperature state, pressure state, moisture state, ultraviolet radiation state, or other state which may change or transform in an identifiable manner in response to a stimulus, as would be readily understood by a worker skilled in the art.

The term “identifiable change” is used with reference to a change in a transitional substance that can be detected including, but not limited to, changes that can be detected by one or more unassisted human senses or with the assistance of instruments and the like.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a device and method which enables the identification of a change in a predetermined condition. The device comprises a fabric material to which is coupled a transitional substance. The transitional substance is configured in order that a change in a predetermined condition, results in an identifiable change in the transitional substance.

In one embodiment of the present invention, the change in the predetermined condition is a change to a threshold or a known difference. For example, the transitional substance can be configured to change or alter in a known fashion upon reaching a particular threshold of a predetermined condition, e.g. if the temperature state reaches a particular temperature. In addition, by way of further example, the transitional substance can be configured to change or alter in a known fashion upon a known deviation or known range of deviation of a predetermined condition, for example when the temperature changes by a known number of degrees from an initial state.

In one embodiment of the present invention, the transitional substance is configured to visually transform upon a change in a predetermined condition, for example the colour of the transitional substance can transform in response to changes in temperature, pressure, ultraviolet radiation or moisture. The type and reason of occurrence of the transformation of the transitional substance can be directly dependent on the desired identifiable change in the predetermined condition. For example, the transitional substance can be configured to transform upon reaching a particular temperature or a particular ultraviolet radiation level.

In one embodiment of the present invention, the transitional substance is provided in a predetermined shape that is easy to read and understand. For example the transitional substance may be formed in a predetermined shape which may be easy to understand regardless of literacy and colour-blindness. In one embodiment, the transitional substance is integrated into clothing, wherein the transitional substance is configured to evaluate a predetermined condition associated with the wearer. In one embodiment, the transitional substance, when integrated into clothing is configured to not adversely affect the comfort of the wearer.

### Fabric Material

A fabric material is a type of material that is configured as a sheet of material and can be used to adhere, cover, or enclose, in whole or in part an entity. For example a fabric material can be a natural or man-made type sheet of material, for example a cotton material, felt material, leather material, wool material, hemp material, polyester material, nylon material, plastic material, vinyl material, leather material or other type of sheet-like material, whether loosely or tightly woven, knitted, or pressed as would be readily understood by a worker skilled in the art.

In one embodiment of the present invention, the fabric material is shaped or fabricated into clothing, for example, adult, child infant, or pet clothing, which can include shirts, blouses, t-shirts, tank tops, undershirts, hats, visors, headbands, pants, shorts, bathing suits, wetsuits, underwear, coats, jackets, jumpers, sleepers, footwear, socks, tights, leotards, gloves, mittens, wrist bands, watches or other type of clothing as would be readily understood by a worker skilled in the art.

In another embodiment of the present invention, the fabric material is shaped in order to form a cover for an apparatus, for example a cover for furniture, chairs, stroller, car seats, bags, or other type of cover as would be readily understood by a worker skilled in the art. The fabric material may also be configured as a bag or other type of carrying device as would be readily understood.

In another embodiment of the present invention, the fabric material is a sheet of material wherein the sheet is configured for a desired purpose, for example a towel, bed sheet, wash cloth, blanket, curtain, bandage, artwork, or other type of sheet-like product as would be readily understood by a worker skilled in the art.

In one embodiment of the present invention, the colour of the fabric material is neutral. In another embodiment, the fabric material is coloured. The selection of the colour of the fabric material can be based on the predetermined shape of the transitional substance, and/or the specific transitional substance to be coupled to the fabric material. For example, the colour of the fabric material can be chosen to be the same as that of the transitional material before it has changed and to contrast with the colour of the transitional material after it has changed in response to stimulus.

### Transitional Substance

The transitional substance is configured to change in the presence of or in response to a change in the predetermined condition. For example, the transitional substance can be a material that is responsive to changes in temperature, changes in pressure, changes in atmospheric composition (e.g. the presence or absence of certain gasses in the surrounding air), changes in moisture level, changes in ultraviolet radiation levels, light exposure, changes in magnetic fields or changes in other predetermined conditions as would be readily understood by a worker skilled in the art.

The transitional substance can be formulated in a plurality of formats, for example inks, dyes, gels, powders, films, or other format as would be readily understood by a worker skilled in the art, provided that the format of the transitional substance (alone or in combination with other elements) is capable of coupling with a fabric material and provided that such elements or other substances in association with the transitional substances do not substantially interfere with the transitional substances' transitional properties. In one embodiment, other elements or substances in association with the transitional substances may enhance the latter's transitional properties and/or the identifiable change detectable.

The transitional substance is configured to be responsive to changes in a predetermined condition. In one embodiment of the present invention, a response of the transitional substance to a change in a predetermined condition is a visual change for example, a colour change, reflectivity change, a transition from opaque to transparent, or other visual change as would be readily understood by a worker skilled in the art.

In another embodiment of the present invention, a response of the transitional substance to a change in a predetermined condition is a tactile response, for example a change from a flexible state to a rigid state, a change from a smooth state to a rough state a volume change, form shape change, or other tactile change as would be readily understood by a worker skilled in the art.

In one embodiment of the present invention, a transitional substance that provides for a tactile change can be used to provide indications that could be interpreted by a visually impaired human such as raised portions in a particular pattern, for example but not limited to a Braille message.

In one embodiment of the present invention, a response to the transitional substance to a change in the predetermined condition is the release or change of an odour or scent. For example a change from no odour to an odour, a change from an odour to no odour, or a change from one odour to another as would be readily understood by a worker skilled in the art.

In one embodiment of the present invention, the transitional substance is capable of reversibly changing in response to a change in a predetermined condition. For example, the transitional substance can change colour in the presence of a stimulus which changes the predetermined condition and upon removal of the stimulus the transitional substance can revert to its original colour.

In another embodiment of the present invention, the transitional substance is configured to irreversibly change in response to a change in a predetermined condition. Upon the change of the transitional substance as a result of a change in the predetermined condition, the transitional substance is not capable of reverting to its original state. For example, if the transitional substance changed colour due to a change in the predetermined condition, this colour change is permanent.

In one embodiment of the present invention, the transitional substance is configured, alone or in combination with other elements, to be coupled to the fabric material in predetermined forms, shapes, and sizes which may or may not change in response to a change in the transitional substance as the result of a change in a predetermined condition. For example the transitional substance can be coupled to the fabric material such that a predetermined image is created, wherein this predetermined image may or may not be visible in one of the original state, or changed state of the transitional substance, when a predetermined condition is changed. For example, in one embodiment of the present invention, the transitional substance is transparent upon initial coupling with the fabric material and upon interaction with a stimulus which changes the predetermined condition; the transitional substance becomes a particular colour. In another embodiment, the transitional substance can change colour, for example from yellow to red in response to a change in a predetermined condition, or other identifiable changes in the transitional substance as would be readily understood by a worker skilled in the art.

In one embodiment of the present invention, the device comprises a transitional substance that responds to a change in a predetermined condition by changing from one visual representation to another. For example, the transitional substance may respond to a change in a predetermined condition by changing from one colour to another, or from one level of reflectivity to another.

In another embodiment of the present invention, the device comprises a transitional substance that responds to changes in a predetermined condition in varying ranges, increments, or predetermined incremental steps. For example, the transitional substance may respond to incremental changes in temperature by shifting through multiple changes in colour or shades of a particular colour. For example, an incremental change in temperature can correspond to a specific colour or a specific shade of a particular colour, for the transitional substance such that when the transitional substance is within a particular temperature range or increment, it is a specific colour. For example, a transitional substance may appear blue at a cold temperature, yellow as a warm temperature and red at a hot temperature. As another example, a transitional substance may appear white at a first UV radiation level, light blue at a UV radiation level denoting a UV index of 5, and navy blue at a UV radiation level denoted by a UV index of 7. A worker skilled in the art would readily understand other ranges, increments or predetermined incremental steps which may be used for the identification of a defined change in a predetermined condition.

In one embodiment of the present invention, the preconfigured shape in which the transitional substance is coupled to the fabric material is representative of the particular predetermined condition which the transitional substance is responsive to changes therein. For example, in one embodiment the transitional substance is responsive to changes in a moisture state and the transitional substance is configured in the shape of a water droplet. In addition, for example, if the transitional substance is responsive to an ultraviolet radiation state, the transitional substance can be configured in the shape of the sun. And for example, if the transitional substance is responsive to a temperature state, the transitional substance can be configured in the shape of a thermometer. Furthermore, if the transitional substance is responsive to a pressure state, the transitional substance can be configured in the shape of a weight. A worker skilled in the art would readily understand a variety of different shapes in which the transitional substance can be configured upon coupling to the fabric material, wherein the predetermined condition is represented by the shape.

In another embodiment of the present invention, the preconfigured shape of the transitional substance may be that of a geometrical shape such as a square, circle, triangle, rectangle, and the like, wherein a change in a predetermined condition can be indicated by the appearance or disappearance of the geometrical shape.

In one embodiment of the present invention, the preconfigured shape and size of the transitional substance is based on the number of changes in a predetermined condition that the transitional substance is responsive to. For example, the preconfigured shape and size of the transitional substance can be selected to respond to one or more incremental changes in a predetermined condition such as the intensity of UV radiation level. In this embodiment, the response to each radiation level would be indicated by a different region of the transitional substance.

In one embodiment of the invention, the selection of the preconfigured shape and size of the transitional substance is based on the location or placement of the transitional substance with respect to the fabric material. For example if the transitional substance is to be located on a large surface of the fabric material, then the size of the transitional substance can be large, and if the transitional substance is to be located on a small surface of the fabric material, then the size of the transitional substance can be small.

In another embodiment of the present invention, the preconfigured shape of the transitional substance is selected such that it can be readily recognized as an indicator of a change in a predetermined condition.

In another embodiment, the preconfigured shape and size of the transitional substance is selected based on production considerations. For example, if the procedure for coupling the transitional substance to the fabric material requires multiple applications of the transitional substance to the fabric material, then the shape of the transitional substance may relatively simple in order to maintain a desired sharpness of the preconfigured shape of the transitional substance.

In one embodiment of the present invention, the location of the transitional substance on the fabric material is selected such that it is visible to those who are monitoring it as an indicator of a change in a predetermined condition, or such that it is exposed to the stimulus that causes a change in a predetermined condition.

In another embodiment of the present invention, the location or placement of the transitional substance can be selected based on packaging considerations. For example, the transitional substance can be located on the fabric material so that when the fabric material is folded, packed, or unpacked, the transitional substance is not folded. As another example, in an embodiment where the transitional substance is configured to respond to a change in a predetermined condition such as the temperature of an entity, then the transitional substance may be located on the fabric material such that it is next to or in close communication with, the target. For example, when the fabric material is clothing, the target can be the wearer and the transitional substance can be positioned on or integrated into the clothing in order that the desired predetermined condition can be evaluated. For example, if the predetermined condition is temperature, the transitional substance can be positioned on the clothing such that it is close to the skin.

In one embodiment of the present invention, the transitional substance is configured to be responsive to stimulus resulting in a change in a predetermined condition, wherein the change is identified by a particular threshold. For example, if the predetermined condition is temperature, the transitional substance can be configured to be responsive to a particular temperature and therefore a change in the predetermined condition is represented by a temperature above or below the selected particular temperature. In one embodiment, the present invention can be used to evaluate body temperature, and the transitional substance can be configured to be responsive when body heat reaches a particular level, which can be defined as a fever for example. The definition of a particular threshold for other predetermined conditions would be readily understood by a worker skilled in the art. For example, a threshold defining a particular ultraviolet radiation level, a particular pressure level or a particular moisture level.

In one embodiment, the transitional substance combined with other elements or substances so as to produce an additional result when the transitional substance changes. Examples of additional substances are, for example, magnetic substances, exothermic substances, luminescent substances, and the like.

In one embodiment, more than one type of transitional substance is coupled to the same fabric material.

### Thermochromic Substance

In one embodiment of the present invention, the transitional substance is a thermochromic substance. In one embodiment of the present invention, the thermochromic substance is a thermochromic ink or dye.

For example, thermochromic inks or dyes can undergo a colour change from a specific colour to colourless in a reversible manner. There are also low temperature thermochromic inks or dyes, which change their colour from colourless at room temperature to a certain colour upon being cooled. Background colour pigments can be provided in combination with the thermochromic substance such that when the thermochromic substance changes to colourless the background pigment becomes dominant for the colour. For example if a yellow background pigment is mixed with a red thermochromic substance the visible colour will change from orange to yellow at the temperature the thermochromic substance changes colour.

For example, thermochromic substances suitable herein are liquid crystals and leucodyes. In one embodiment, both classes of substances are encapsulated in suitable microcapsules.

For example, liquid crystals are sensitive to temperature changes and change colour even in a temperature range of about 0.1° C., for example from black to a colour. The application of liquid crystals requires specialized printing which can result in elevated manufacturing costs.

For example, leucodyes typically change colour in a temperature increment of about 3-6° C., and in most cases changed from coloured to clear or transparent. Leucodyes can be applied by printing or by admixing in a polymer masterbatch.

For example, fabric materials printed with leucodye thermochromic inks can change from one colour to another, rather than transitioning from coloured to clear. This can be achieved with an ink that combines a leucodye with a permanent-coloured ink formulation. For example, the ink may be formulated as a green ink by adding a blue leucodye to a yellow ink. In its cool state, the printed ink layer is green, and once warmed, reverts to yellow as the leucodye becomes clear or translucent. Leucodyes can be designed to change colour at various temperature ranges, from as low as about −25° C. up to about 66° C. In addition, a range of colours can be produced.

In one embodiment, in order to function, a leucodye requires a combination of chemicals working together in a system. This special system of materials can be protected from the components of the ink to which it is being added through microencapsulation. The microencapsulation process takes a small droplet of the leucodye and coats a protective wall around it. The leucodye microcapsules can contain the complete colour-changing thermochromic substance, which, when added to inks, give them their colour-changing properties. The microcapsules can be large, for example about 3-5 microns, and therefore they can be about ten times larger than an average pigment particle. Therefore in one embodiment, special considerations are involved in printing inks with these relatively large particles and include coarser screen mesh, heavier ink laydown, in order to obtain a desired shape of the thermochromic substance, for example.

In one embodiment of the present invention, the thermochromic substance is manufactured by Chromatic Technologies, Inc.

In one embodiment, the thermochromic substance is manufactured by Colour Change Corporation.

In one embodiment the thermochromic substance is coupled to a fabric material in the shape of a garment. The thermochromic substance in this instance can be formulated so that its threshold for colour change is 38.1° C. or 0.1° above normal body temperature. In this embodiment the predetermined condition is the body temperature of the wearer and the crossing of the threshold indicates a potential fever.

In one embodiment, the thermochromic substance is coupled to a fabric material in the shape of a cloth not meant to be worn, such as, for example a washcloth. The thermochromic substance in this instance can be formulated so that its threshold for colour change is 37.6° C. In this embodiment, the predetermined condition is the temperature of a liquid, such as a bottle of milk formula or an infant's bathwater. Temperatures above the threshold have the possibility of injuring an infant.

Thermochromic dyes and their application to fabrics and textiles are discussed, for example, in U.S. Pat. No. 4,681,791; U.S. Pat. No. 4,717,710; U.S. Pat. No. 5,4804,852; U.S. Pat. No. 6,990,688; U.S. Pat. No. 6,635,797; U.S. Pat. No. 5,389,093; U.S. Pat. No. 5,501,945; U.S. Pat. No. 6,585,555; and U.S. Pat. No. 7,105,715

### Photochromic Substance

In one embodiment of the present invention, the transitional substance is a photochromic substance. In one embodiment of the present invention, the photochromic substance is a photochromic ink or dye.

For example, photochromic inks can change from clear when indoors to coloured when taken outdoors. Specifically, they can exhibit colour in response to exposure to ultraviolet light from sunlight, black lights, or similar sources. Ultraviolet light can change the chemical structure of the photochromic substance and can make it absorb colour like a dye. The photochromic substance can then revert to a clear state when the ultraviolet source is removed. The colour change can occur thousands of times, depending on the application. A photochromic substance can also change from one colour to another when it is combined with a pigment ink, for example similar to the leucodye-ink manufacturing process. These photochromic inks can be available in a full range of colours.

Another example of a photochromic substance is dye crystals, wherein these materials are uncoloured in the shadow and become coloured when exposed to ultraviolet radiation. The ultraviolet radiation can cause chemical changes in the dye crystal. There are both reversibly and irreversibly colour changing materials available. Suitable application techniques of dye crystals are ink printing or admixing into polymeric masterbatches.

For example, in their pure state, photochromic substances are powdered crystals that are typically dissolved in the inks to which they are added. These powdered crystals may be microencapsulated in their own system, as with leucodye microcapsules. Microencapsulating photochromic substances can enable them to be used in inks that cannot dissolve them, such as water-based inks.

In one embodiment the photochromic substances are extremely sensitive to light such as silver chloride or silver halide-based chemicals.

In one embodiment of the present invention, the photochromic substance is manufactured by Chromatic Technologies, Inc.

In one embodiment of the present invention, the photochromic substance is manufactured by Colour Change Corporation.

In one embodiment, the photochromic substance is formulated so that its threshold for colour change is ultraviolet radiation concentrations above UV index 5. In this embodiment the predetermined condition is the concentration of UV radiation and the threshold is the amount of UV radiation likely to cause sunburn.

Photochromatic dyes and their application to fabrics and textiles are discussed, for example in U.S. Pat. No. 3,961,948; U.S. Pat. No. 5,208,132; U.S. Pat. No. 5,985,381; U.S. Pat. No. 5,846,614; U.S. Pat. No. 6,238,442; U.S. Pat. No. 6,037,101; U.S. Pat. No. 7,265,358; and U.S. Pat. No. 7,205,088.

### Hydrochromic Substance

In one embodiment of the present invention, the transitional substance is a hydrochromic substance. In one embodiment of the present invention, the hydrochromic substance is a hydrochromic ink or dye.

A hydrochromic substance is responsive to a change in moisture level, for example upon interaction with water the hydrochromic substance changes states in an identifiable manner.

In one embodiment a hydrochromic substance can be a water-soluble material, wherein in a dry state the hydrochromic substance is visible and upon interaction with water the hydrochromic material dissolves thereby transferring into a transparent state. This format of a hydrochromic substance is an irreversible substance, wherein it is not capable of returning to its original state upon drying of the substance.

In another embodiment of the present invention, the hydrochromic substance provides an identifiable indicator of a change in moisture state in a reversible manner, wherein initially the hydrochromic substance is in a first state when dry and in changes into a second state when wet, wherein upon drying the hydrochromic substance reverts to its original state.

In one embodiment of the present invention, the hydrochromic substance is manufactured by B&H Colour Change Ltd.

Hydrochromic dyes and their application to textiles and fabrics are discussed, for example in U.S. Pat. No. 6,680,205; and U.S. Pat. No. 5,130,290.

### Piezochromic Substance

In one embodiment of the present invention, the transitional substance is a piezochromic substance. In one embodiment of the present invention, the piezochromic substance is a piezochromic ink or dye.

In one example the piezochromic substance is configured as a thermochromic substance which responds to a temperature increase caused by applied pressure. In this configuration the piezochromic substance can be configured as a reversible indicator of applied pressure.

In another embodiment, the piezochromic substance comprises a dye, which is encapsulated into microcapsules. Upon application of pressure these capsules break and release the dye, which can become visible. In this embodiment, the microcapsules can be configured to response to a predetermined pressure level for example an applied pressure between about 14 to 140 kPa. In one embodiment, the colour intensity of the piezochromic substance can be proportional to the amount of pressure applied, for example the greater the pressure the darker the colour. In this embodiment, the piezochromic substance transition is of an irreversible nature, as the identification of a change is pressure was achieved by the destruction of microcapsules, in which the materials for achieving the identification were encapsulated.

Piezochromic dyes and their application to fabrics or textiles are discussed for example in International Publication No. WO/2005/092995; Japanese Patent No. 42880; Japanese Patent No. 46079; Japanese Patent No. 132857; U.S. Pat. No. 5,320,784; U.S. Pat. No. 5,501,945; U.S. Pat. No. 6,261,469 and U.S. Pat. No. 6,517,763.

Coupling of a Transitional Substance with a Fabric Material

The coupling of a transitional substance and the fabric material can be enabled by a variety of different methods, wherein these methods would be directly dependent on the type of fabric material, for example natural or man-made fabric material, or for example loosely knit fabric or tightly knit fabric and the format of the transitional substance, for example ink, dye, gel, film, powder, and the like.

The placement of the transitional substance on the fabric material may be influenced by the type of fabric material being used. For example, on a jacket incorporating both natural and man-made fabric materials, the placement of the transitional substance may be impacted by the relative cost or simplicity of attaching the transitional substance to the one fabric material over the other. Generally, however, the placement of the transitional substance will be chosen largely to enhance the function of the transitional substance as a detector of changes in the predetermined condition.

In one embodiment of the present invention, the transitional substance is designed to be removably attached to the fabric material. Methods of removably attaching the transitional substance can include without being limited to adhesives, magnets, buttons, breakable stitching, or Velcro as would be readily apparent to a worker skilled in the art.

In one embodiment, the transitional substance is an ink, wherein the transitional substance can be coupled to the fabric material by printing, screening or other method as would be readily understood by a worker skilled in the art. In one embodiment, professional printing services may be employed to couple the transitional substance to the fabric material. Suitable printing processes include rotary printing, where the ink is applied to the fabric using a rotary drum. In other embodiments, a screen printing process machine, a roto print machine, stamping machine, or Flexo print machine may be used to couple the transitional substance to the fabric material. As is known in the art, the choice of coupling process depends on several factors, including the predetermined shape of the transitional substance, or the type of transitional substance used. For example, if the predetermined shape of the transitional substance is complex, then a coupling process that requires only one application of the transitional substance may be a suitable choice. Alternatively, the type of transitional substance used may determine the choice of coupling process.

In one embodiment, the fabric material and means of coupling the transitional substance to the fabric material are chosen so as to promote greater durability of the coupling between the transitional substance and the fabric material. For example, looser knitted fabric material may increase the transitional material's ability to bond with the fabric, increasing the durability of the resulting application.

In one embodiment of the present invention, where the fabric material is itself coloured, a primer base can be applied to the fabric material prior to coupling the transitional substance to the fabric material in order to improve the colour visibility and accuracy of the indication of a change in a predetermined condition by the transitional substance.

In another embodiment of the present invention, the transitional substance is a dye, wherein the fabric material can be dipped into the dye enabling the coupling thereof with the fabric material. A worker skilled in the art would readily understand a number of ways to couple a transitional substance in the form of a dye with a fabric material, wherein the selection of method can depend on how much and/or where the transitional substance is to couple with the fabric material.

In another embodiment, the transitional substance is configured as a heat or pressure transfer-type configuration, wherein the coupling of the transitional substance with the fabric material can be performed through the use of heat or pressure, which can enable the adhesion of the transfer to the fabric material, such as an “iron-on”. The selection of technique can depend directly on the type of sensitivity of the transitional substance, as would be readily understood by a worker skilled in the art. In addition, alternate techniques for the coupling of a transfer type transitional substance with the fabric material, as would be readily understood.

In one embodiment of the present invention, the transitional substance is coupled to a label prior to being coupled to the fabric material, wherein this coupling of the transitional substance to a label can be performed using one or more of the preceding methods. Suitable labels can include vinyl or fabric patches, 100% cotton label tape, 100% polyester label tape with fused or woven edges, or label tapes that are blends of polyester and cotton or other label configurations as would be known to a worker skilled in the art.

In one embodiment of the present invention a label may be permanently coupled to the fabric material by sewing or other methods as is known in the art.

In one embodiment, the label is designed to be removably attached to a fabric material and the label comprises an attachment system such as Velcro, one or more buttons, or button-holes, adhesive material and the like as would be known to a worker skilled in the art.

In one embodiment, the transitional substance is coupled to a label that is thinner than the fabric material to which it is being attached. In this case, the transitional material can be integrated into the fabric material such that the thinner label material is on one side of the fabric material and the label can be viewed through an aperture in the fabric material. This allows more sensitive transfer material to be placed in direct contact with an entity, for example, human skin, while still allowing for a thicker fabric material.

Other methods of coupling a transitional substance with a fabric material would be readily understood by a worker skilled in the art.

The invention will now be described with reference to specific examples. It will be understood that the following examples are intended to describe embodiments of the invention and are not intended to limit the invention in any way.

### Examples

### Example 1

In one embodiment of the present invention, the fabric material is clothing for example a shirt, hat, sweater, pants or other garment and the transitional substance is a photochromic ink which is responsive to a predetermined level of ultraviolet radiation.

The photochromic ink is printed or screened onto the clothing at predetermined locations, wherein potential sun exposure is typical, for example on the back of a shirt or the top of the shoulders of a shirt. The photochromic ink is formed in the shape of a sun and this photochromic ink is configured to change colour, or change from transparent to a colour, upon reaching a predetermined level of ultraviolet radiation.

This configuration of the device can provide a means for determining if the wearer of the clothing is being exposed to an undesired level of ultraviolet radiation. This can enable the prevention of sunburn for example and can provide a means for decreasing the chance of developing skin cancer as it relates to overexposure to sunlight.

This configuration of the device can be particularly applied to infant or children's clothing, for example T-shirts, shirts or hats. In this manner a parent can be given a visual identifier, for example the changing of the colour of the sun to red, when the infant or child is being exposed to an undesired level of ultraviolet radiation.

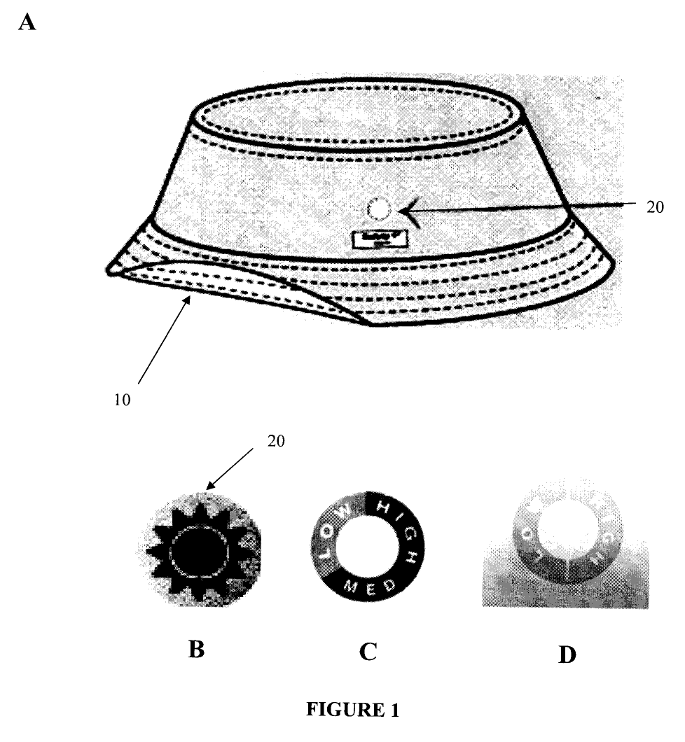

FIG. 1A illustrates an embodiment of the this device type in the format of a hat 10 and the photochromic substance is formed such that its predetermined shape is that of a sun 20 as illustrated in FIG. 1B. FIGS. 1C and 1D illustrate alternate predetermined shapes of the photochromic substance according to other embodiments of the present invention.

### Example 2

In one embodiment of the present invention, the fabric material is clothing for example a shirt, sweater, pants or other garment and the transitional substance is a thermochromic ink which is responsive to a predetermined temperature.

The thermochromic ink is printed or screened onto the clothing at predetermined locations, wherein the body temperature can be more readily transferred to the clothing, for example within a region of the body core, namely the torso of the wearer. The thermochromic ink is formed in the shape of a thermometer and this thermochromic ink is configured to change colour, or change from transparent to a colour, upon reaching a predetermined temperature.

This configuration of the device can provide a means for determining if a person has a fever or elevated temperature, and can be practical when the wearer of the clothing is unable to communicate this type of condition. For example, this type of device can be used on infant clothing, as a child is merely able to communicate that something is wrong without articulating the reason.

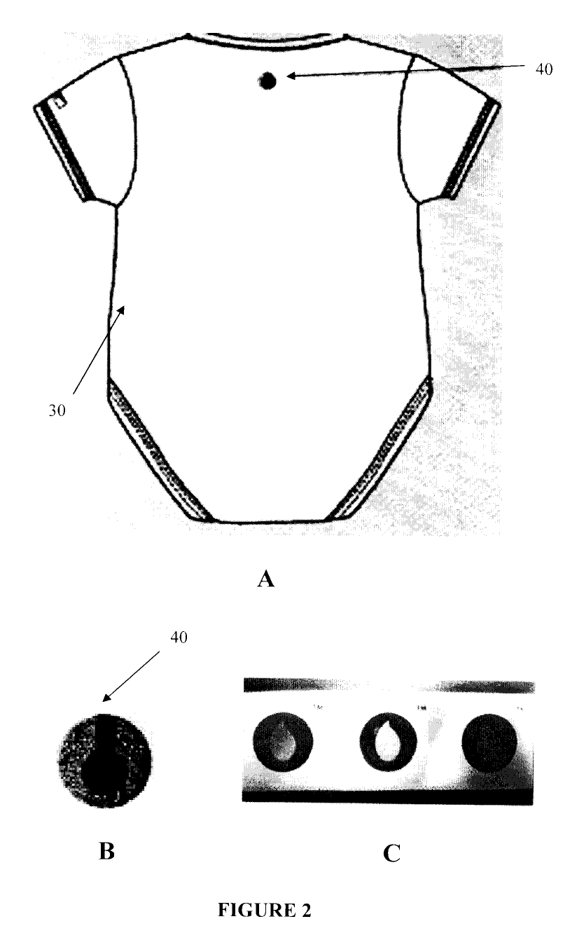

FIG. 2A illustrates an embodiment of the device type in the format of a sleeper 30 and the thermochromic substance is formed to have a predetermined shape which is that of a thermometer 40 as illustrated in FIG. 2B.

### Example 3

In one embodiment of the present invention, the fabric material is a washing towel or cloth and the transitional substance is a thermochromic ink which is responsive to a predetermined water temperature. The thermochromic ink is printed or screened onto the fabric material at predetermined locations and can be formed in the shape of a water droplet and this thermochromic ink is configured to change colour, or change from transparent to a colour, at a predetermined temperature. For example FIG. 2C illustrates a predetermined shape for a thermochromic substance for this example, according to one embodiment of the present invention.

This configuration of the device can provide a means for determining if bath water is at a desired level, prior to placing a child or person into the water. For example, the thermochromic ink can be configured to turn red if the water is above a predetermined temperature, which may be representative of water that is too hot for bathing.

### Example 4

In one embodiment of the present invention, the fabric material is clothing for example pants, underwear or other garment and the transitional substance is a hydrochromic ink which is responsive to moisture.

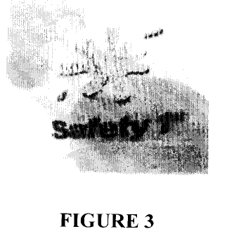

The hydrochromic ink is printed or screened onto the clothing at predetermined locations, wherein moisture is likely to come into contact with the clothing. The hydrochromic ink is formed in the shape of a puddle and this hydrochromic ink is configured to change colour, change from transparent to a colour, or disappear upon coming in contact with moisture or reaching a predetermined moisture level. An example of a predetermined shape of a hydrochromic substance according to one embodiment of the present invention is illustrated in FIG. 3

In this configuration the device can be used to aid in the determination of whether a child requires a diaper change for example.

In one embodiment, the transition of the hydrochromic ink moves through a range of colours and therefore this format of device can provide a means for aiding in the toilet training of a child, as one would be able to identify when a child may want to go to the toilet but may be trying to restrain the desire.

### Example 5

In one embodiment of the present invention, the fabric material is clothing for example a shirt, sweater, coat or other garment and the transitional substance is a piezochromic ink which is responsive to a desired pressure level.

The piezochromic ink is printed or screened onto the clothing at predetermined locations, wherein pressure may increase and the piezochromic ink is formed in the shape of a weight and this piezochromic ink is configured to change colour, or change from transparent to a colour, upon application of a particular pressure level.

In this configuration the device may be helpful in determining if the restraint system of a car seat is sufficiently tight in order to ensure safety. For example upon the fastening of the restraints, the piezochromic ink can change colour upon achieving a desired pressure in order to ensure that the child is securely fastened in the car seat.

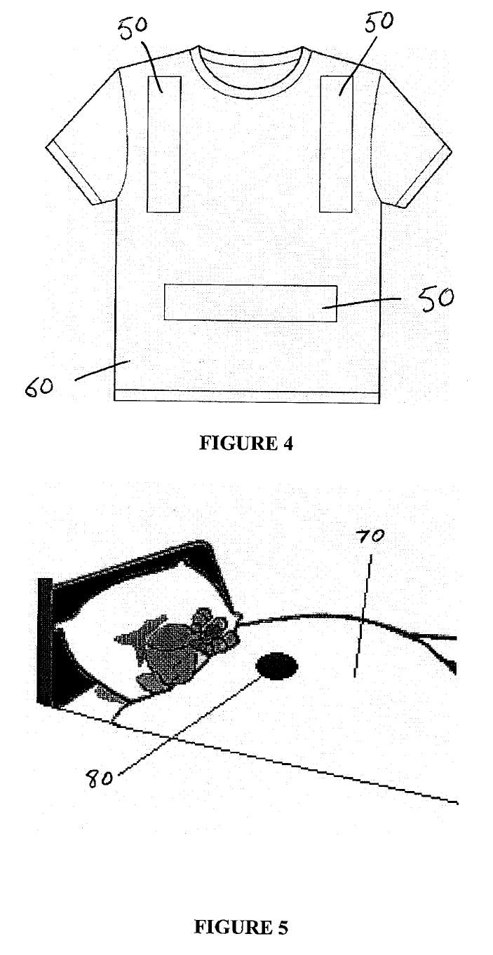

An example of a shirt with strips of piezochromatic ink located in areas that will come into contact with car seat restraints is illustrated in FIG. 4. With reference to FIG. 4, a transitional substance 50 is coupled to the fabric material, or shirt 60. Transitional substance 50 incorporates piezochromic dyes.

### Example 6

In one example, the fabric material is a sheet, for example a bed sheet or blanket and the transitional substance is a thermochromic ink which is responsive to a certain temperature level.

The thermochromic ink is printed or screened onto the fabric material at predetermined locations and this thermochromic ink is configured to change colour, or change from transparent to a colour, at a predetermined temperature.

An example of a blanket with a transitional substance is illustrated at FIG. 5. With reference to FIG. 5, the blanket 70 has a transitional substance 80 coupled to it. The transitional substance 80 incorporates a thermochromic dye.

In this configuration, the device may be helpful in determining if the body temperature of a person (such as a medical patient) or an infant sleeping on a bed is too hot or too cold. In order that the transitional substance reflect the person or infant's body temperature and not the surrounding temperature, the transitional substance should be coupled to the fabric material such that it comes in direct contact with the person's body.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

What is claimed is:

1. A device for identifying a change in a predetermined condition, said device comprising:
a) a fabric material; and
b) a transitional substance coupled to the fabric material, the transitional substance being configured to transform in response to a change in the predetermined condition, wherein the transitional substance transforms in an identifiable manner;
thereby enabling identification of the change in the predetermined condition;
wherein the device does not require washing or drying after the transformation.

2. The device according to claim 1, wherein the predetermined condition is related to ultraviolet radiation level, temperature level, moisture level or pressure level.

3. The device according to claim 1, wherein the transitional substance is a thermochromic substance.

4. The device according to claim 1, wherein the transitional substance is a photochromic substance.

5. The device according to claim 1, wherein the transitional substance is a hydrochromic substance.

6. The device according to claim 1, wherein the transitional substance is a piezochromic substance.

7. The device according to claim 1, wherein the transitional substance transforms upon reaching a predetermined temperature level, moisture level, ultraviolet radiation level or pressure level.

8. The device according to claim 1, wherein the transitional substance transforms in response to predetermined incremental changes in temperature level, moisture level, ultraviolet radiation level, or pressure level.

9. The device according to claim 1, wherein the transitional substance is coupled to the fabric material in a predetermined shape.

10. The device according to claim 9, wherein the predetermined shape is representative of the predetermined condition.

11. The device according to claim 1, wherein the transitional substance transforms from one colour to another colour.

12. The device according to claim 1, wherein the transitional substance transforms from colourless to a colour or from a colour to colourless.

13. The device according to claim 1, wherein the transitional substance transforms from one shade of a colour to another shade of the colour.

14. The device according to claims 1, wherein the fabric material is configured as clothing.

15. The device according to claim 14, wherein the clothing is configured for a child.

16. A method for identifying a change in a predetermined condition; the method comprising:
a) providing a device including a fabric material and a transitional substance coupled to the fabric material, the transitional substance being configured to identifiably transform in response to a change in the predetermined condition;
b) detecting a transformation in the transitional substance, said transformation being a response of the transitional substance to a change in the predetermined condition;
thereby identifying a change in the predetermined condition.

17. The method according to claim 16, wherein the predetermined condition is related to ultraviolet radiation level, temperature level, moisture level or pressure level.

18. The method according to claim 16, wherein the transitional substance is a thermochromic substance.

19. The method according to claim 16, wherein the transitional substance is a photochromic substance.

20. The method according to claim 16, wherein the transitional substance is a hydrochromic substance.

21. The method according to claim 16, wherein the transitional substance is a piezochromic substance.

22. The method according to claim 16, wherein the transitional substance transforms upon reaching a predetermined temperature level, moisture level, ultraviolet radiation level or pressure level.

23. The method according to claim 16, wherein the transitional substance transforms in response to incremental changes in temperature level, moisture level, ultraviolet radiation level, or pressure level.

24. The method according to claim 16, wherein the transitional substance is coupled to the fabric material in a predetermined shape.

25. The method according to claim 26, wherein the predetermined shape is representative of the predetermined condition.

26. The method according to claim 16, wherein the transitional substance transforms from one colour to another colour.

27. The method according to claim 16, wherein the transitional substance transforms from colourless to a colour or from a colour to colourless.

28. The method according to claim 16, wherein the transitional substance transforms from one shade of a colour to another shade of the same colour.

29. The method according to claim 16, wherein the fabric material is configured as clothing.

30. The method according to claim 29, wherein the clothing is configured for a child.
